(19) United States
(12) Patent Application Publication
(10) Pub. No.: US 2003/0218358 A1
(43) Pub. Date: Nov. 27, 2003

(54) Dual mode vehicle side door

(76) Inventor: Seonho Hahn, Hercules, CA (US)

Correspondence Address: Richard C. Litman, LITMAN LAW OFFICES, LTD., P.O. Box 15035, Arlington, VA, 22215, US

(21) Appl. No.: 10/427,971

(22) Filed: May 2, 2003

Related U.S. Application Data
(60) Provisional application No. 60/382,572, filed on May 24, 2002.

(51) Int. Cl. B60J 5/06

(52) U.S. Cl. 296/155

(57) ABSTRACT

An automotive vehicle door which may be optionally opened and closed by a sliding or pivoting movement to allow passenger ingress/egress. The door may be mounted for forward (type B) or rearward (type A) pivoting movement. The door will open toward the rear when the sliding option is selected. The exterior surface of the door is provided with separate handles to selectively initiate respective sliding or pivoting movement. The door incorporates a single handle which may be moved to respective positions to initiate either sliding or pivoting movement for the type A door.

### CROSS-REFERENCE TO RELATED APPLICATION

This application claims the benefit of U.S. Provisional Patent Application Serial No. 60/382,572, filed May 24, 2002.

### BACKGROUND OF THE INVENTION

1. Field of the Invention

The present invention generally relates to closures. More specifically, the present invention is drawn to a door for an automotive vehicle which may optionally be opened and closed by either a sliding or pivoting motion.

2. Description of Related Art

Automotive vehicle doors have traditionally employed horizontal pivoting movement to open and close. This pivoting movement has historically proven to be popular and dependable. Occasional exceptions, e.g. the vertical pivoting gull wing, have not caught the consumer's fancy and have disappeared into oblivion. However, the advent of the van/mini-van presented a new set of problems. The increased size of the van/mini-van makes for tight parking in garages and mall parking lots. Thus, the pivoting door would be the cause of many dings and scratches when opened against the car parked in the adjoining space. The invention of the sliding van door has proven to be an adequate solution to the above stated problem. There are however, many consumers who still prefer the ease and efficient motion that is required to open the pivoting door and would employ both opening modes if available. An invention that would allow a user to quickly and easily select a preferred option (sliding or pivoting) would certainly be a welcome addition to the art.

U.S. Pat. Nos. 4,110,934 (Zens), 4,135,760 (Grossbach), 5,398,988 (DeRees et al.) and 6,183,039 B1 (Kobut et al.) disclose door systems for automotive vehicles, which systems incorporate both sliding and pivoting movement. It is noted, however, that the pivoting movement is only enough to allow the door to move in position for sliding movement. In none of the instant patents is the door pivoted to a position to allow for normal passenger ingress and/or egress.

U.S. Pat. No. 4,058,932 (Peterson et al.) is drawn to a mounting apparatus for a door which is normally pivoted for opening or closing a passageway in an enclosure. The mounting apparatus also permits the door to be slid between the walls of the enclosure if desired. To slide a door between the walls of an automobile would present very complicated design problems.

U.S. Pat. No. 3,750,334 (Slaybaugh) discloses a hinging arrangement for a sliding door which would permit the door to be opened or closed with a swinging movement in the event of failure of the sliding mechanism.

U.S. Pat. No. 6,276,092 B1 (Neo) shows a combined sliding and pivoting window assembly. No provision is made to incorporate dual movement in a single window.

None of the above inventions and patents, taken either singly or in combination, is seen to disclose a combined sliding and pivoting door as will subsequently be described in the instant invention.

### SUMMARY OF THE INVENTION

The present invention is drawn to an automotive vehicle door which may be optionally opened and closed by a sliding or pivoting movement to allow passenger ingress/egress. As contemplated, the door is classified as either a Type A or a Type B door. The Type A door is mounted for rearward pivoting movement; the Type B door is mounted for forward pivoting movement. Because of safety and design requirements, both A and B types will open toward the rear when the sliding option is selected. However, if applied in non-automotive applications, the opening sliding movement can be toward the front if desired.

The exterior surface of the door is provided with separate handles to selectively initiate respective sliding or pivoting movement. The interior surface of the door incorporates a single handle which may be moved to respective positions to initiate either sliding or pivoting movement.

Accordingly, it is a principal object of the invention to provide an improved door opening and closing system.

It is another object of the invention to provide a selectively optional door opening and closing system.

It is a further object of the invention to provide a door opening and closing system in which the door may be optionally opened or closed by a sliding or pivoting movement.

Still another object of the invention is to provide a door opening and closing system which is efficient and easy to operate.

It is an object of the invention to provide improved elements and arrangements thereof in an apparatus for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a dual mode vehicle side door of the type B opened in a rearward sliding direction according to the present invention.

FIG. 2 is a perspective view of a vehicle door of the type B opened in a forward pivoting direction according to the present invention.

FIG. 3 is a perspective view of a hinge support and rail guide system for the door of the type B illustrated in FIG. 2 according to the present invention.

FIG. 4 is a perspective view of a vehicle door of the type A opened in a rearward pivoting direction according to the present invention.

FIG. 5 is a partial, exploded view of a hinge support and rail guide system for the door of the type A illustrated in FIG. 4 according to the present invention.

FIG. 6 is a partial, perspective view of an interior and exterior door latch mechanism of a type A door according to the present invention.

FIG. 7 is a partial, perspective view of exterior door handles of a type B door according to the present invention.

FIG. 8 is a perspective view of the type A door of FIG. 4 opened in a sliding mode according to the present invention.

Similar reference characters denote corresponding features consistently throughout the attached drawings.

### DETAILED DESCRIPTION OF THE PREFERRED EMBODIMENTS

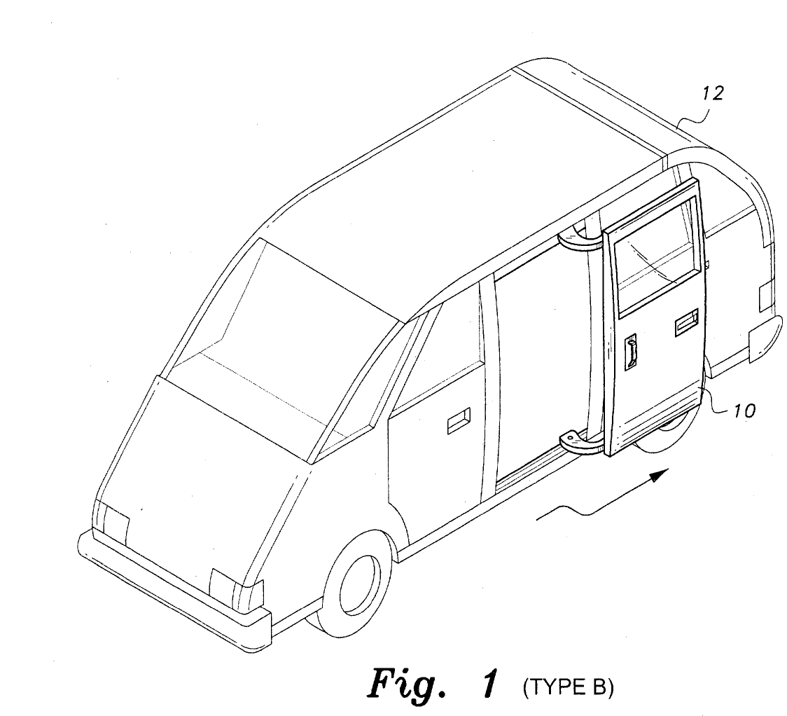

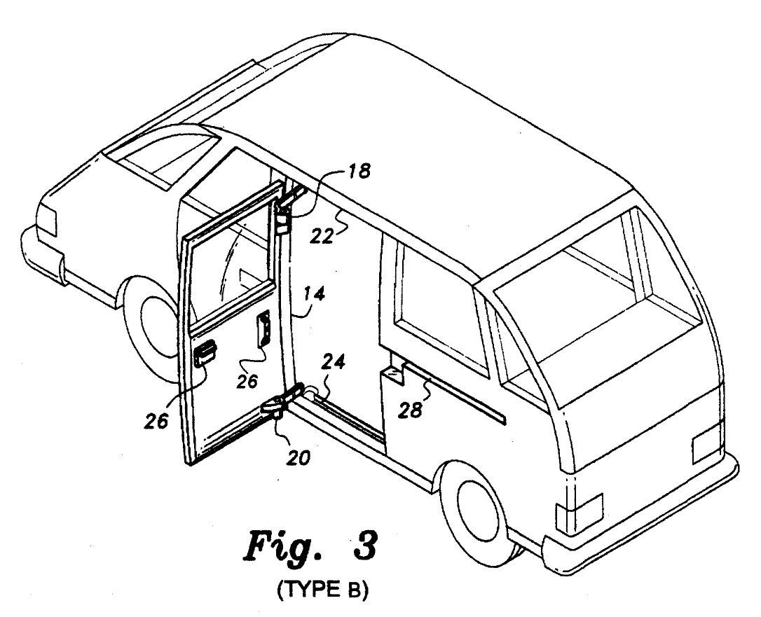

Attention is first directed to FIGS. 1-3 wherein the door 10 of the present invention is shown mounted on a vehicle 12. Although vehicle 12 is depicted as a van, it is noted that the door may be mounted on vehicles of any body style. Door 10 slides toward the rear of the vehicle to permit passengers to enter and/or leave. As shown in the instant embodiment, door 10 is mounted to pivot in a forward direction i.e. toward the front of the vehicle. As best seen in FIG. 3, door 10 is mounted for pivoting movement via mount 14 to vehicle grade hinges for rotational movement in upper and lower sliding hinges 18 and 20. Upper and lower sliding hinges 18, 20 are respectively mounted to upper and lower rail guides 22 and 24 positioned at the top and bottom walls of the van for sliding or pivoting movement thereon. Rail guides 22, 24 are substantially coextensive with the width of the door opening of the vehicle. Two separate latch mechanisms 26 (one for sliding and one for pivoting) are mounted on the interior of the door. A guide track 28 is provided in the rear exterior of the vehicle body to receive one of the mechanisms 26 for sliding movement therein.

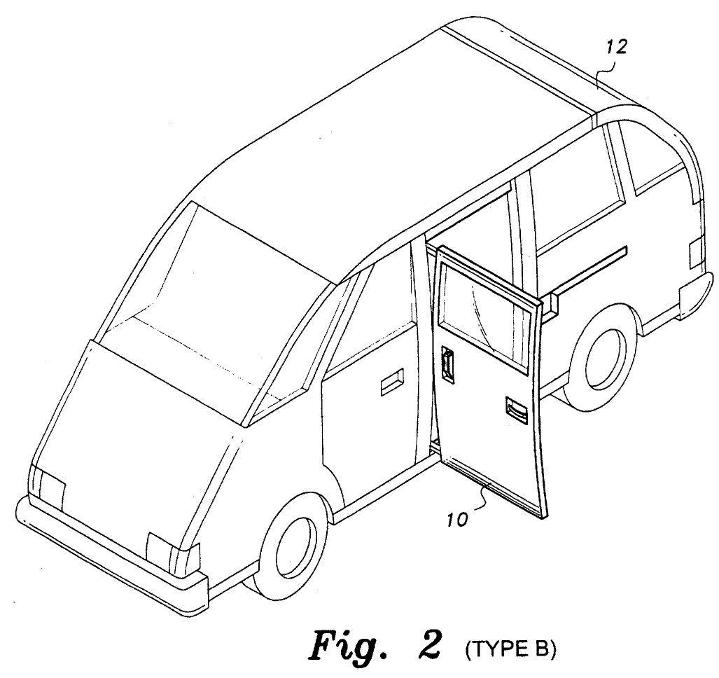

When it is desired to pivotally open door 10, latch mechanism 26 is unlocked from the guide track 28 and sliding hinges 18, 20 are locked at the forward ends of rail guides 22, 24 to prevent the hinges from sliding there along. Door 10 may then be pivoted in a forward direction (as shown in FIGS. 2 and 3) to allow passenger ingress or egress. If sliding movement is chosen, mechanism 26 remains locked in guide track 28 for sliding movement therein. Sliding hinges 18, 20 are unlocked to allow sliding movement on rail guides 22, 24. Door 10 can then be opened as shown in FIG. 1.

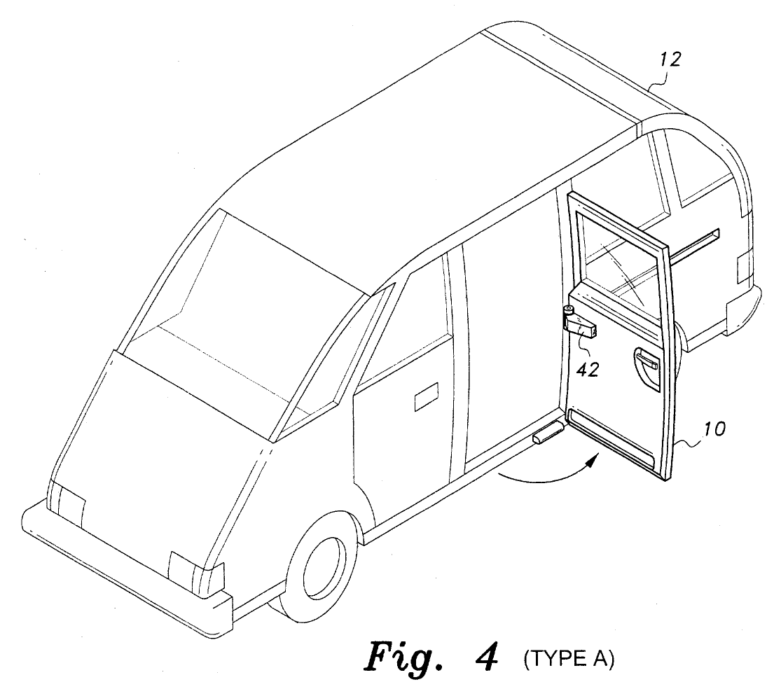

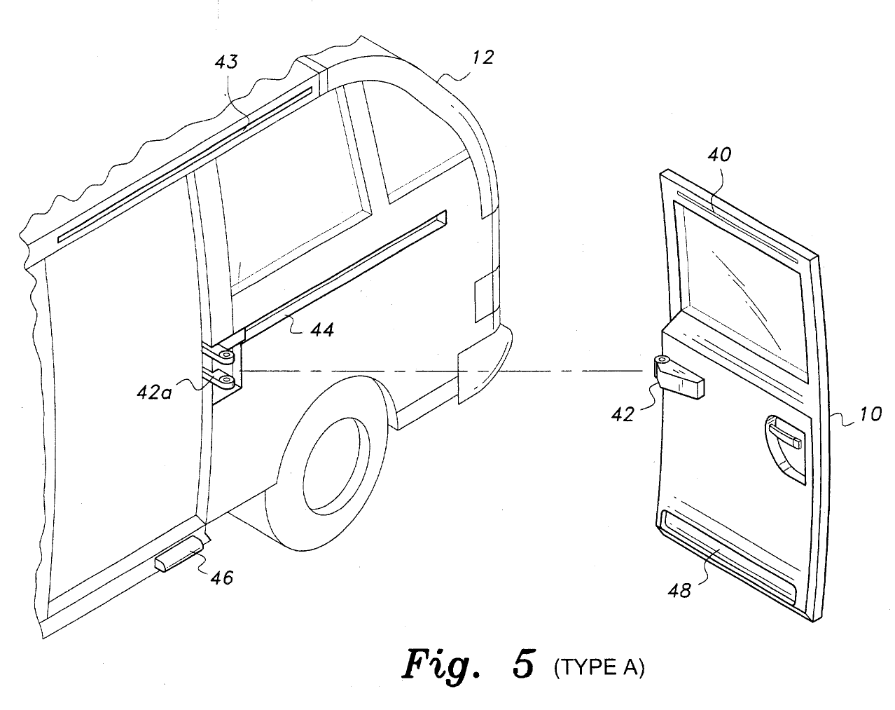

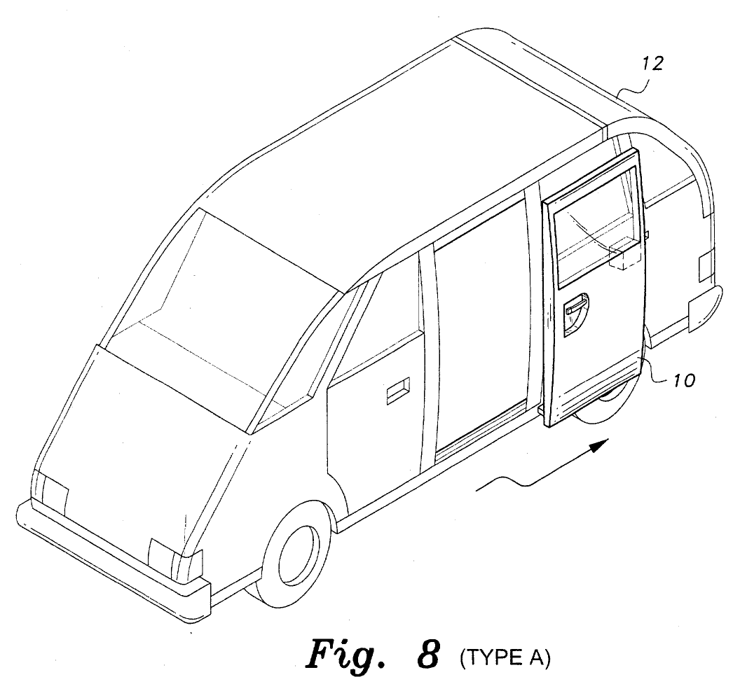

In a second embodiment of the present invention, illustrated in FIGS. 4 and 5, door 10 can be mounted to pivot in a rearward direction. A dual mode hinge system 42, 42a is provided to attach door 10 to vehicle 12. Hinge part 42 is mounted for pivoting movement in hinge part 42a. Hinge part 42a is disposed adjacent a guide track 44. Part 42a is locked at the forward end of track 44 but may be unlocked for sliding movement therein. A slide rail 40 is disposed at the top of door 10. Rail 40 is adapted to slide in a rail support guide 43 located along the exterior of the vehicle. A slide support 46 is mounted at the bottom of the vehicle opening. A slot 48 is formed in the bottom edge door 10 to receive slide support 46. If pivoting opening is selected, hinge part 42a is locked at the forward end of track 44 to prevent part 42a from sliding. Part 42 is unlocked to permit pivoting movement and door 10 may be opened by pivoting the same in a rearward direction as shown. If sliding opening is preferred, part 42 is locked to prevent pivoting movement in part 42a. Simultaneously, part 42a is unlocked to allow sliding movement in track 44. Door 10 may then be slid to an open position as shown in FIG. 8.

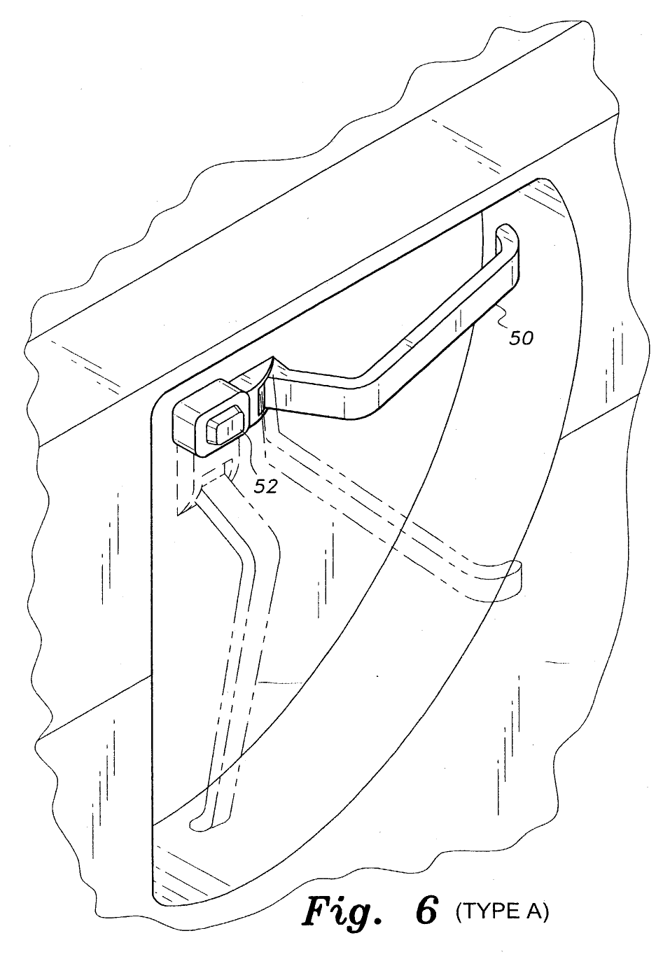

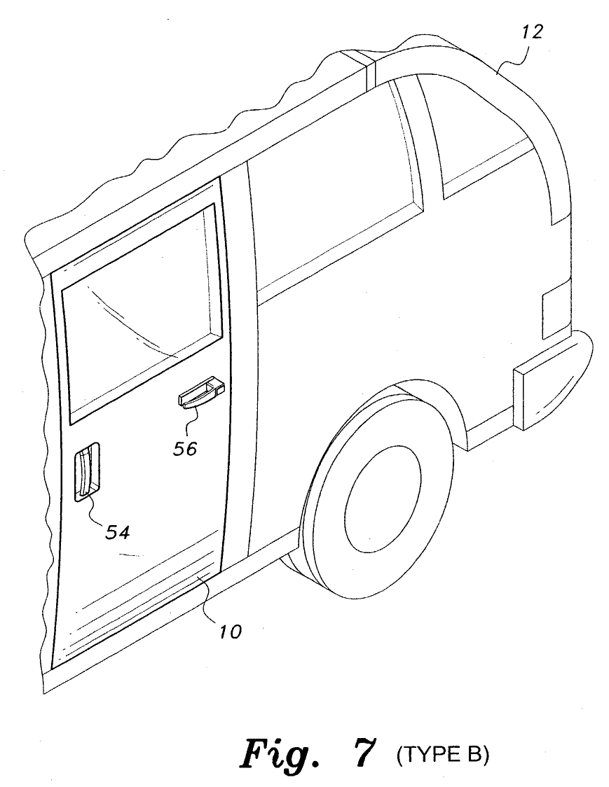

As presently contemplated and illustrated in FIG. 6, conventional mechanisms (not shown) can be utilized to allow a passenger, from both inside and outside, to select a mode of door operation. For the type A door, a lever 50 is provided to operate the mechanisms and is mounted on the inside surface of door 10. In a horizontal position lever 50 engages the mechanisms to operate the door in a pivoting mode. A push button 52 allows a user to disengage and move lever 50 to a vertical position (phantom lines) whereby the lever engages the mechanisms to allow the door to operate in a sliding mode. Lever 50 also functions to unlatch the door for opening by movement away from the door surface (phantom lines). Exteriorly (FIG. 7), separate handles 54 and 56 are respectively provided for initiating sliding or pivoting movement of the type B door.

It is to be understood that the present invention is not limited to the sole embodiments described above, but encompasses any and all embodiments within the scope of the following claims.

I claim:

1. A dual mode vehicle door including:
a vehicle having an opening therein to permit passenger ingress and egress;
a door disposed on said vehicle for covering and uncovering said opening;
means attached to said vehicle and said door for pivotally moving said door to fully cover or fully uncover said opening;
a track system affixed to said vehicle, said means disposed on said track system for sliding movement therein, whereby said door can be slidably moved to fully cover or fully uncover said opening.

2. A dual mode vehicle door according to claim 1, wherein said means includes at least one hinge member attached to said door.

3. A dual mode vehicle door according to claim 2, wherein said opening has a top wall and a bottom wall and wherein said track system is disposed in said top wall and said bottom wall.

4. A dual mode vehicle door according to claim 3, wherein said vehicle has a rear exterior sidewall and wherein said track system is disposed in said rear exterior sidewall.

5. A dual mode vehicle door according to claim 2, wherein said opening has a top wall and said vehicle has a rear exterior sidewall and wherein said track system is disposed in said top wall and said rear exterior sidewall.

6. A dual mode vehicle door according to claim 5, wherein said door has an interior bottom edge and wherein said track system is disposed in said interior bottom edge.

7. A dual mode vehicle door including:
a vehicle having an opening therein to permit passenger ingress and egress, said opening having a top wall and a bottom wall;
a door disposed on said vehicle for covering and uncovering said opening, said door having a top edge and a bottom edge;
a first track disposed in said top wall;
a second track disposed in said bottom wall;
a first hinge disposed in said first track for sliding movement therein;
a second hinge disposed in said second track for sliding movement therein; and
a pair of vehicle grade hinges mounted to said door each of said pair having respective ends positioned in said first hinge and said second hinge for rotational movement therein.

8. A dual mode vehicle door as recited in claim 7, wherein said vehicle has a rear exterior surface and wherein said door has an interior surface;
a third track disposed on said rear exterior surface of said vehicle;
a latch member disposed on said interior surface of said door, said latch member adapted to slide in said third track member.

9. A dual mode vehicle door including:
a vehicle having an opening therein to permit passenger ingress and egress, said opening having a top wall and a bottom wall;
an exterior rear surface positioned on said vehicle;
a door disposed on said vehicle for covering and uncovering said opening, said door having a top edge and a bottom edge;
a first track disposed in said top wall;
a second track disposed on said exterior rear surface;
a third track disposed said bottom edge of said door; and
a hinge attached to said door adjacent said second track and adapted for sliding movement therein.

10. A dual mode vehicle door according to claim 9, wherein said door has an interior surface and said hinge is mounted on said interior surface for optional sliding and pivoting movement.

11. A dual mode vehicle door according to claim 10, including a lever and push-button mechanism disposed on said interior surface for optionally selecting sliding and pivoting movement.
